(19) United States
(12) Patent Application Publication
(10) Pub. No.: US 2009/0165327 A1
(43) Pub. Date: Jul. 2, 2009

(54) Method of de-wrinkling garments and device for facilitating same

(76) Inventor: Jacquelyn Nekovar, Westlake Village, CA (US)

Correspondence Address: LIU & LIU, 444 S. FLOWER STREET SUITE 1750, LOS ANGELES, CA, 90071, US

(21) Appl. No.: 12/317,717

(22) Filed: Dec. 22, 2008

Related U.S. Application Data
(60) Provisional application No. 61/008,760, filed on Dec. 21, 2007.

(51) Int. Cl. F26B 7/00; F26B 19/00

(52) U.S. Cl. 34/380; 34/60

(57) ABSTRACT

A device and process for conveniently removing wrinkles from dried clothes. The inventive device includes an outer shell enclosing a core of water absorbent material. The device may be spherical, cubic, or be in other regular or irregular geometric shapes, having a finish that would not damage or affect the tumbling of clothes in the dryer. The foam material in the shell is saturated with water prior to tossing into the clothes dryer with the clothes to be de-wrinkled. Moisture from the foam material in the shell is introduced into the dryer chamber from the dryer heat, which relaxes wrinkles on clothing.

### CROSS REFERENCE

This application claims priority of U.S. Provisional Patent Application No. 61/008,760 filed Dec. 21, 2007, which is fully incorporated by reference as if fully set forth herein.

### BACKGROUND OF THE INVENTION

1. Field of the Invention

The present invention relates to a device for removing wrinkles from dry clothes.

2. Discussion of Related Art

Wrinkles on garments, if not intentionally or originally designed, are generally viewed as unsightly and undesirable. Wrinkles in dry clothes may be the result from scrunching, folding, creasing, etc. A somewhat common cause for wrinkled clothes is the tumble machine drying process practiced by consumers in most households. A common occurrence is that a busy consumer would either forget or is not available to remove a load of dried clothes from a clothes dryer when the drying cycle has been completed (e.g., clothes placed into the dryer as a person is leaving for work). Tumbled, dried clothes are in a jumbled state, which when left to stand in the clothes dryer after drying (often times for hours) would form wrinkles under the weight of the clothes. Further, during the wash process, washing machines use agitators and rotating drums to mix and rotate clothes, which also leave clothes crumpled up even prior to transfer to the dryer.

Heretofore, to remove wrinkles from a piece of dried clothing, a steam iron is used to smooth out the wrinkles over a flat ironing board. This is a time consuming process that requires certain skill, attention and temperament of the consumer.

What is needed is a convenient way of removing wrinkles from dried clothes.

### SUMMARY OF THE INVENTION

The present invention is directed to a device and process for conveniently removing wrinkles from dried clothes. The inventive device includes an outer shell enclosing a core of water absorbent material. The device may be spherical, cubic, or be in other regular or irregular geometric shapes, having a finish that would not damage or affect the tumbling of clothes in the dryer.

To use the device to remove wrinkles in dried clothes, the foam material in the shell is saturated with water (e.g., the shell with the foam material is soaked in a container of water). The device is tossed into a laundry or clothes dryer with the clothes to be de-wrinkled. The dryer is run at the desired heat cycle and time, either to a completely dry condition, or in a slightly moist condition (e.g., a fluff cycle or a dry cycle is run at appropriate heat level (e.g., low heat) for a length of time (e.g., several minutes)). Moisture from the foam material in the shell is introduced into the dryer chamber during the heat cycle, which relaxes wrinkles on clothes.

The shell may be made of a permeable material that can withstand the anticipated heat of a dryer, or has a perforated shell that withstands heat of the dryer, so as to allow moisture to be released from the core absorbent material through the shell into the dryer. The types of core material may be selected depending on its characteristics (e.g., sponge or foam cell size and absorbent characteristics), the intended heat cycle, the type of clothes, etc., to provide an appropriate rate of release of moisture into clothes in the dryer.

In one embodiment, the device has a spherical hard plastic (e.g., PVC) shell, provided with holes uniformly distributed about the spherical shell. A foam material (e.g., sponge) is retained in the shell. The outer surface of the shell may be smooth, or textured (e.g., pimples, studs or nodules on the surface) to facilitate mixing and/or fluffing of clothes as they tumble in the dryer.

In a further embodiment, a piece of additive pellet (i.e., an applicator) is placed into the foam material (e.g., baking soda, freshener, fabric softener, anti-static agent, scent, etc.). The pellet may be inserted through a large enough opening in the shell. The shell may include two hinged halves, which may be opened to place the pellet in the foam material.

In addition to or in lieu of an applicator pellet, the foam material may be impregnated with the active applicator material (freshener, fabric softener, anti-static agent, scent), which may be activated and/or released upon saturation of the foam material with water. Alternatively, the device may be soaked in different types of solutions having active applicator materials for providing desired treatment to clothes. For example, the device may be soaked to saturate the sponge with a solution containing freshener, fabric softener, anti-static agent, scent, etc. Instead of soaking just prior to use, the core of the device may be pre-soaked at the point of manufacture, and sold as a packaged product to consumers.

Different pre-packaging devices may correspond to different types of solutions and/or core materials, for applications to clothes of various types of materials (e.g., delicate versus heavy clothes). The device may be configured to prevent user access to the absorbent material, or to allow user to access the core of absorbent material (e.g., to replace the sponge). For the latter, different replacement cores having different characteristics and/or solutions pre-impregnated could be sold separately to allow user freedom to replace the core at will to suit the desired results.

Further, instead of a shell and absorbent material combination, the device may have a unitary construction, wherein the entire device is an absorbent material that may be pre-impregnated with a solution, and having a perforated outer skin of a tough material that can withstand the environment in a tumble dryer (e.g., a block of soft, hard, flexible or rigid foam having a perforated outer skin of a closed cell material).

### BRIEF DESCRIPTION OF THE DRAWINGS

For a fuller understanding of the nature and advantages of the invention, as well as the preferred mode of use, reference should be made to the following detailed description read in conjunction with the accompanying drawings. In the following drawings, like reference numerals designate like or similar parts throughout the drawings.

FIG. 1 is a perspective view of a dewrinkler ball in accordance with one embodiment of the present invention.

FIG. 2 is a sectional view taken alone line 2-2 in FIG. 1.

FIG. 3 is a perspective view of a dewrinkler ball in accordance with another embodiment of the present invention.

FIG. 4 is a sectional view taken alone line 4-4 in FIG. 3.

FIG. 5 is a schematic view of a dewrinkler ball with the shell opened in accordance with another embodiment of the present invention.

### DETAILED DESCRIPTION OF THE PREFERRED EMBODIMENTS

The present description is of the best presently contemplated mode of carrying out the invention. This description is made for the purpose of illustrating the general principles of the invention and should not be taken in a limiting sense. The scope of the invention is best determined by reference to the appended claims. The invention has been described herein in reference to various embodiments and drawings. It will be appreciated by those skilled in the art that variations and improvements may be accomplished in view of these teachings without deviating from the scope and spirit of the invention.

The present invention is directed to a device and process for conveniently removing wrinkles from dried clothes. The inventive device includes an outer shell enclosing a core of water absorbent material substantially filling the shell. The device may be spherical, cubic, or be in other regular or irregular geometric shapes, having a finish that would not damage or negatively affect the tumbling of clothes in the dryer.

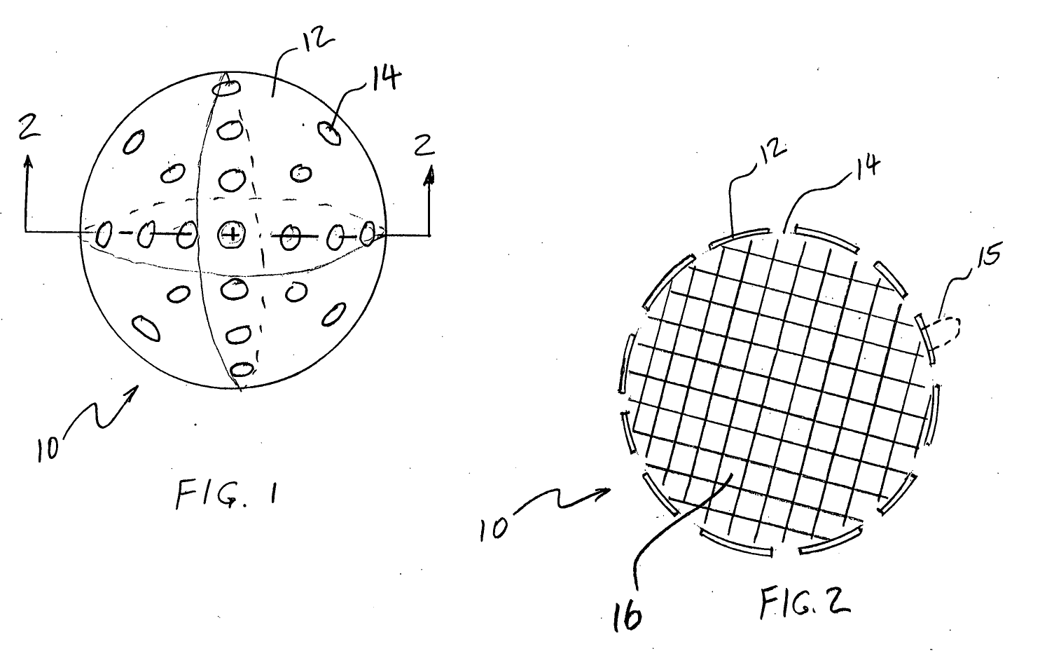

Referring to the embodiment shown in FIG. 1, the device is in the form of a dewrinkler dryer ball 10, having a substantially spherical shell 12, in which perforations (i.e., through-holes 14) are provided throughout. The holes 14 are circular, but may take on other shapes (e.g., slits), and may be distributed randomly or in substantially uniformly or a particular orderly fashion across the spherical shell 12. Held and filling the inside of the shell 12 is a water absorbent material, such as a foam material, such as a sponge 16. Instead of a perforated shell 12, the shell of the dewrinkler ball 10 may be made of a permeable material that can withstand the anticipated heat of a dryer, which allows moisture to be released from the core absorbent material through the shell into the dryer. The types of core material may be determined and selected depending on its characteristics (e.g., sponge or foam cell size and absorbent characteristics), the intended operating heat cycle, the type of clothes, etc., to provide an appropriate rate of release of moisture into clothes in the dryer. For example, if a slower rate of moisture release is intended at a particular heat level, or a slower rate of moisture release at a higher heat level, the cell size of the sponge 16 should be relatively smaller. To provide a smaller cell size in the sponge 16, either a sponge of the particular cell size is used, or the sponge 16 may be oversized compared to the interior size of the shell 12, and is compressed to fit into the inside of the shell 12.

To use the dewrinkler ball 10 to remove wrinkles in dried clothes, the sponge 16 in the shell 12 is saturated with water. This can be done by soaking the dewrinkler ball 10 in a container of water. The sponge 16 is allowed to hold as much water as it can hold without appreciable dripping. The dewrinkler ball 10 is tossed into the clothes dryer with the dried clothes to be de-wrinkled. The clothes dryer is run at the desired heat cycle and time, either to a completely dry condition, or in a slightly moist condition (e.g., a warm fluff cycle or a dry cycle is run at appropriate heat level (e.g., low heat) for a length of time (e.g., 10-30 minutes)). Moisture from the foam material in the shell is introduced into the clothes dryer chamber during the heat cycle. The moisture relaxes existing wrinkles on clothes. If the clothes are left slightly moist after the heat cycle, the clothes should be taken out of the clothes dryer immediately or shortly after the cycle, and hung to completely dry, before wrinkles again set in. The dewrinkler ball 10 may be reused for another drying run for clothes.

The shell 12 may be made of a hard, rigid, or flexible plastic (e.g., PVC, polyurethane, etc.). The shell 12 may be a unitary piece, or with sealed, welded or glued seams. The diameter of the shell 12 may be approximately 2 to 3 inches, for example, and the diameter of the circular holes 14 may be 0.25 to 0.5 inch, for example. The sponge 16 may have a cell porosity that holds 1-2 oz. of water without appreciable dripping. The outer surface of the shell 12 may be smooth, or textured (e.g., a uniform or random distribution of raised pimples, studs or nodules on the surface, representatively shown in dotted line 15 in FIG. 2) to facilitate mixing and/or fluffing of clothes as they tumble in a clothes dryer.

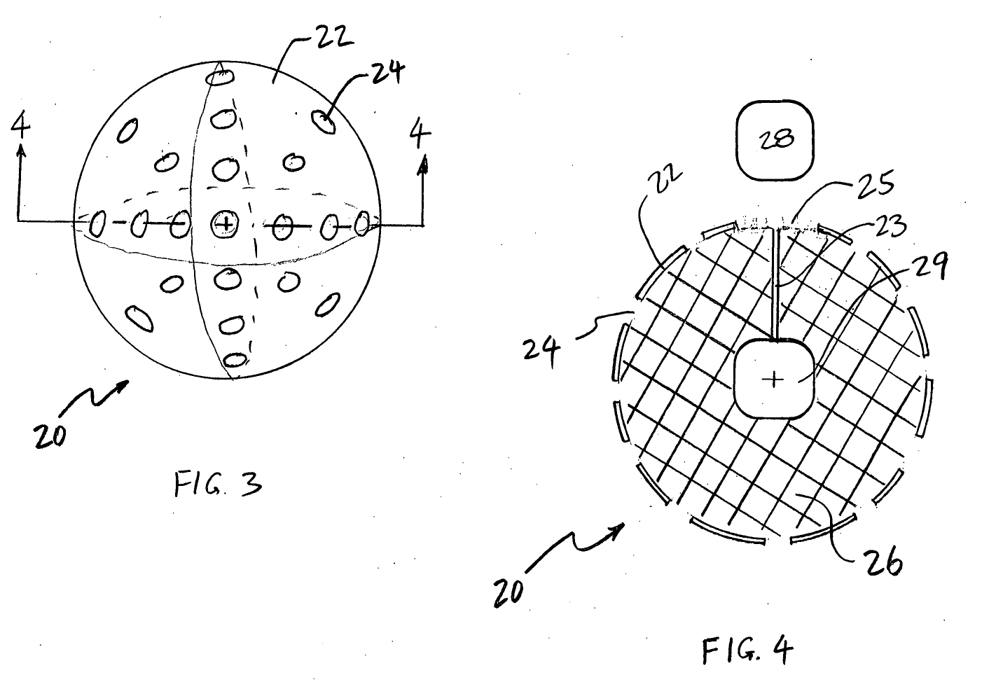

In an alternate embodiment, a piece of additive pellet (i.e., an active applicator material, e.g., baking soda, freshener, fabric softener, anti-static agent, scent, etc.) is placed into the foam material. The pellet may be disc or bead shaped. Referring to FIG. 3, the dewrinkler ball 20 is similar to the dewrinkler ball 10 (having a shell 22, holes 24), with the exception that the dewrinkler ball 20 in the present embodiment is provided with a sponge 26 that receives a pellet 28 at its center. The pellet 28 may be inserted through a large enough opening in the shell 22. A dedicated opening 25 may be provided if the holes 24 are not large enough to let the pellet pass through the shell 22. A slit opening 23 is provided in the sponge 26, which opening expands to provide an enlarged passage for the pellet 28. A cavity 29 may be provided at the center of the sponge 26, which may be sized and shaped to hold the pellet 28 snugly in place during tumbling in clothes dryer. With the pellet 28 in place, when the dewrinkler ball 20 is soaked in water, the material of the pellet 28 is dissolved into the water in the sponge 16. As the dewrinkler ball 20 is subsequently run in the clothes dryer, the active applicator material in the pellet 28 is released with the moisture from the dewrinkler ball 20, thereby treating the clothes in the dryer, depending on the particular active applicator material.

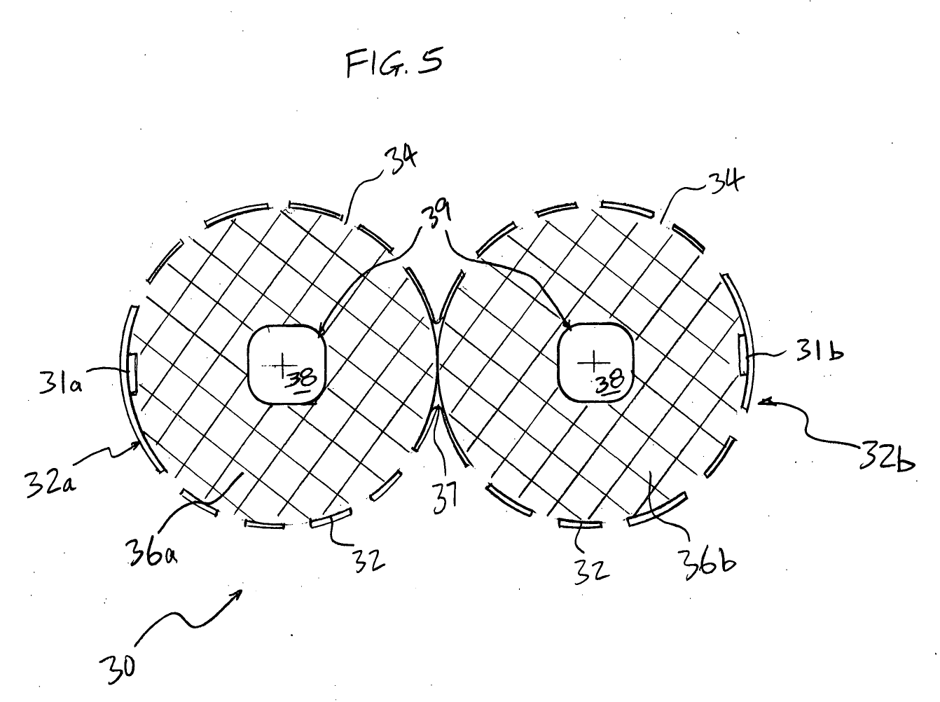

In a further embodiment, instead of a unitary shell that cannot be opened as in the embodiment of FIGS. 1 to 4, the dewrinkler ball 30 may be provided with a shell 32 that can be opened to provide access to the inside of the shell. FIG. 5 shows the dewrinkler ball 30 with the shell 32 opened. The shell 32 includes holes 34 as in the previous embodiments. However in this embodiment, the shell 32 includes two halves 32a and 32b (i.e., hemispherical halves in the illustrated embodiment, which may be opened to reveal the inside of the shell. In the illustrated embodiment, the sponge 36 is also in two hemispherical halves 36a and 36b, as shown in FIG. 5. As in the embodiment of FIG. 4, an applicator pellet 38 may be placed directly in the cavity 39 at the center of the sponge 36. Alternatively, instead of a sponge 36 having two halves as shown, a single spherical sponge as in the embodiment of FIG. 4 may be provided, and the pellet 38 may be inserted into the cavity 39 through a slit opening in the sponge 36, similar to the situation in FIG. 4. The two halves 32a and 32b of the shell 32 may be hingedly coupled at 37 (e.g., a thinly molded joint), and a clasp 31a and a complementary clasp anchor 31b is provided on the two halves and on the inside of the shell layer (i.e., clasp locking onto the anchor from the inside of the shell), so that the shell halves 32a and 32b may be closed to securely hold the sponge 36 within. The inside clasp and anchor structure avoids potential snagging of clothes. Alternatively, the two halves of the shell may be coupled to form a sphere by a number of locking fittings along the edge of the hemispherical halves (not shown).

In addition to or in lieu of an applicator pellet as in the previous embodiments, the sponge may be impregnated with an active applicator material (freshener, fabric softener, anti-static agent, scent), which may be activated and/or released upon saturation of the sponge with water. Alternatively, the dewrinkler ball may be soaked in a desired type of solution having one or more active applicator materials for providing desired treatment(s) to clothes. For example, the dewrinkler ball may be soaked to saturate the sponge with a solution containing freshener, fabric softener, anti-static agent, scent, etc. Instead of soaking just prior to use, the sponge of the dewrinkler ball may be pre-soaked at the point of manufacture, and sold as a packaged product to consumers. The dewrinkler ball may be reused with or without other solutions after the pre-soaked solution is spent.

Different pre-packaged dewrinkler balls may correspond to different types of applicator pellets, applicator solutions, and/or core foam materials, for different types of treatment applications to clothes of various types of materials (e.g., delicate versus heavy clothes). The dewrinkler balls may be configured to prevent user access to the absorbent material, or to allow user to access the core of absorbent material (e.g., to replace the sponge, as in the embodiment of FIG. 5). For the latter, different replacement foam material cores (i.e., sponges) having different characteristics and/or applicator pellets, and/or pre-impregnated active applicator materials could be sold separately to allow user freedom to replace the core at will to suit the desired results.

Further, instead of a dewrinkler ball having a separate shell and a water absorbent core material combination, the dewrinkler ball may have a unitary water absorbent construction, wherein the entire ball is an absorbent material (which may be pre-impregnated with an applicator solution or include an applicator pellet), but having a perforated outer skin of a tougher impermeable material that can withstand the environment in a tumble dryer (e.g., a block of soft, hard, flexible or rigid foam having a perforated outer impermeable skin or a perforated coating of a closed cell structure).

While the invention has been particularly shown and described with reference to the preferred embodiments, it will be understood by those skilled in the art that various changes in form and detail may be made without departing from the spirit, scope, and teaching of the invention. A person skilled in the art will recognize that the instrument incorporating the essence of this invention can also be used for storage of other types of collapsible items made from plastic or other soft and/or flexible materials. Accordingly, the disclosed invention is to be considered merely as illustrative and limited in scope only as specified in the appended claims.

1. A device for use in a laundry dryer for removing wrinkles on dry clothes, comprising:
a shell structured to allow moisture to pass through; and
a water absorbent material inside the shell.

2. The device of claim 1, wherein the shell comprises a moisture permeable structure.

3. The device of claim 3, wherein the shell comprises a layer that that is perforated.

4. The device of claim 3, wherein holes are provided on the shell in a substantially uniform distribution.

5. The device of claim 3, wherein the shell comprises a perforated skin on the water absorbent material.

6. The device of claim 1, wherein outer surface of the shell is smooth.

7. The device of claim 1, wherein outer surface of the shell is textured.

8. The device of claim 1, wherein the water absorbent material substantially fills the inside the shell.

9. The device of claim 8, wherein the water absorbent material is a foam material.

10. The device of claim 9, wherein the foam material is a sponge.

11. The device of claim 1, wherein the water absorbent material includes an applicator material.

12. The device of claim 11, wherein the applicator material comprises a pellet.

13. The device of claim 12, wherein the water absorbent material includes a cavity for receiving the pellet.

14. The device of claim 13, wherein the water absorbent material includes a slit through the material leading from the shell to the cavity.

15. The device of claim 11, wherein the applicator material comprises an active applicator material impregnated in the water absorbent material, which may be activated and/or released upon saturation of the water absorbent material with water.

16. The device of claim 1, wherein the water absorbent material includes a cavity for receiving an application pellet.

17. The device of claim 15, wherein the shell includes two halves, allowing access to the inside of the shell to place the pellet in the water absorbent material.

18. The device of claim 1, wherein the shell is spherical in shape.

19. A method of removing wrinkles on dry clothes, comprising:
providing a device as in claim 1;
soaking the device in water, such that the water absorbent material holds water;
placing the device and the dry cloths in a laundry dryer;
running the laundry dryer on low heat, thereby releasing moisture from the device to relax wrinkle on the clothes.

20. The method of claim 19, wherein the device comprises an applicator material.
